(19) United States
(12) Patent Application Publication
(10) Pub. No.: US 2013/0247777 A1
(43) Pub. Date: Sep. 26, 2013

(54) LOW-INERTIA THERMAL SENSOR IN A BEVERAGE MACHINE

(71) Applicants: Stefan Etter, Kehrsatz (CH); Martin Ziegler, Koniz (CH); Frank Krauchi, Epautheyres (CH)

(72) Inventors: Stefan Etter, Kehrsatz (CH); Martin Ziegler, Koniz (CH); Frank Krauchi, Epautheyres (CH)

(73) Assignee: NESTEC S.A., Vevey (CH)

(21) Appl. No.: 13/991,349

(22) PCT Filed: Dec. 1, 2011
(86) PCT No.: PCT/EP2011/071474

§ 371 Date: Jun. 3, 2013

(30) Foreign Application Priority Data
Dec. 2, 2010 (EP) 10193426.3

(51) Int. Cl. G01K 7/02

(52) U.S. Cl. CPC G01K 7/02
USPC 99/323.3; 374/179

(57) ABSTRACT

The invention pertains generally to a thermal sensor and a controlled heating system, in a beverage preparation machine. In particular, the invention relates to a thermal sensor comprising: connectors; an electrical coupling circuit; a sensing element having at least one measurable electrical quantity varying with the temperature of the sensing element; The sensing element is electrically coupled with the connectors through the electrical coupling circuit so as to allow measuring said electrical quantity at the level of the connectors. The sensor comprises a support having a first surface and a second surface thermally coupled and electrically isolated. The sensing element is thermally coupled with the first surface. The second surface is adapted to be thermally coupled with an area which temperature is to be measured.

### TECHNICAL FIELD

The field of the invention pertains generally to a thermal sensor, a heater and a controlled heating system.

In particular, it relates to a controlled heating system adapted to heat liquid circulating in the liquid circuit of a beverage preparation machine.

For the purpose of the present description, a “beverage” is meant to include any liquid food, such as tea, coffee, hot or cold chocolate, milk, soup, baby food, hot water or the like. A “capsule” is meant to include any pre-portioned beverage ingredient within an enclosing packaging of any material, in particular an air tight packaging, e.g. plastic, aluminum, recyclable and/or bio-degradable packaging and of any shape and structure, including soft pods or rigid cartridges containing the ingredient.

### BACKGROUND ART

Various beverage machines, such as coffee machines, are arranged to circulate liquid, usually water, from a water source that is cold or heated by heating means, to a mixing or infusion chamber where the beverage is actually prepared by exposing the circulating liquid to a bulk or pre-packaged ingredient, for instance within a capsule. From this chamber, the prepared beverage is usually guided to a beverage dispensing area, for instance to a beverage outlet located above a cup or mug support area comprised or associated with the beverage machine. During or after the preparation process, used ingredients and/or their packaging is evacuated to a collection receptacle.

Most coffee machines possess heating means, such as a heating resistor, a thermoblock or the like. For instance, U.S. Pat. No. 5,943,472 discloses a water circulation system for such a machine between a water reservoir and a hot water or vapour distribution chamber, for an espresso machine. The circulation system includes valves, a metallic heating tube and a pump that are interconnected with each other and with the reservoir via a plurality of silicone hoses that are joined together by clamping collars. 2009/043865, WO 2009/074550, WO 2009/130099 and PCT/EP09/058562 disclose further filling means and related details of beverage preparation machines.

In-line heaters for heating circulating liquid, in particular water are also well known and are for example disclosed in CH 593 044, DE 103 22 034, DE 197 11 291, DE 197 32 414, DE 197 37 694, EP 0 485 211, EP 1 380 243, EP 1 634 520, FR 2 799 630, U.S. Pat. No. 4,242,568, U.S. Pat. No. 4,595,131, U.S. Pat. No. 4,700,052, U.S. Pat. No. 5,019,690, U.S. Pat. No. 5,392,694, U.S. Pat. No. 5,943,472, U.S. Pat. No. 6,246,831, U.S. Pat. No. 6,393,967, U.S. Pat. No. 6,889,598, U.S. Pat. No. 7,286,752, WO 01/54551 and WO 2004/006742.

Thermoblocks are in-line heaters through which a liquid is circulated for heating. They comprise a heating chamber, such as one or more ducts, in particular made of steel, extending through a mass of metal, in particular made of aluminium, iron and/or another metal or an alloy, that has a high thermal capacity for accumulating heat energy and a high thermal conductivity for the transfer the required amount of the accumulated heat to liquid circulating therethrough whenever needed. Thermoblocks usually include one or more resistive heating elements, for instance discrete or integrated resistors, that convert electrical energy into heating energy. The heat is supplied to the thermoblock's mass and via the mass to the circulating liquid. To be operative to heat-up circulating water from room temperature to close to the boiling temperature, e.g. 90 to 98° C., a thermoblock needs to be preheated, typically for 1.5 to 2 minutes.

Instant heating heaters have been developed and marginally commercialised in beverage preparation machines. Such heaters have a very low thermal inertia and a high power resistive heater, such as thick film heaters. Examples of such systems can be found in EP 0 485 211, DE 197 32 414, DE 103 22 034, DE 197 37 694, WO 01/54551, WO 2004/006742, U.S. Pat. No. 7,286,752 and WO 2007/039683.

In a beverage preparation machine, the use of thermo-block heaters requires an accurate fast-reacting thermally-controlled heating system. The expected regulating performances are even higher for system including instant heating heaters, since the temperature variations of such devices are faster and potentially more important in comparison of those of thermo-block heaters.

More precisely, heating devices need to be driven by control means, so as to deliver a liquid at an expected temperature, with a typical acceptable error margin within +/−2%. To achieve this goal, various heater command policies may be implemented, based upon regular measurements of the actual temperature of the liquid. A simple heater command policy may be summarized as follow: if the measured temperature is lower than an expected value, the power delivered to the heater may be raised up to a given level; when the measured temperature reaches the expected value, the power delivered to the heater may be reduced or even cut off. The efficiency and the accuracy of these controlled heating systems are greatly dependent upon the thermal inertia of the thermal sensor, and its ability to detect as quickly as possible any changes of the liquid's temperature.

Thus, there is a need to reduce the thermal inertia of the thermal sensor, by providing a simple, fast-reacting to temperature changes, inexpensive and reliable thermal sensor. There is also a need to improve the thermal regulation of temperature-controlled heating systems, comprised in a machine for preparing hot beverages, such as tea or coffee.

### SUMMARY OF THE INVENTION

The objective problems are solved by the independent claims of the present invention, which are directed to a thermal sensor, an assembly, a heating system, and a beverage preparation machine, respectively. The dependent claims develop further advantages of each solution.

According to a first aspect, the invention relates to a thermal sensor comprising:
connectors;
an electrical coupling circuit,
a sensing element having at least one measurable electrical quantity varying with the temperature of the sensing element.

The sensing element is electrically coupled with the connectors through the electrical coupling circuit so as to allow measuring said electrical quantity at the level of the connectors. The sensor further comprises a support having a first surface and a second surface. The first and the second surfaces are thermally coupled and electrically isolated. The sensing element is thermally coupled with the first surface. The second surface is adapted to be thermally coupled with an area which temperature is to be measured.

The second surface of the thermal sensor is intended to be fixed directly onto a monitored area, typically on a heater's outer surface, or at least thermally coupled with said monitored area by any thermal coupling means (for instance, a layer of thermal conductive material such metal). Since the second surface, the first surface and the sensing element are thermally coupled, the heat radiated by the monitored area is directly transmitted through the support to the sensing element. Hence, it allows fast thermal transfers through the support between the monitored area of the heater and the sensing element itself. By contrast, conventional thermal sensors according to the prior art do not provide a direct thermal coupling between the monitored area of the heater and the sensing element, since their sensing element is covered by a protecting member, such a casting compounds, a casing, a metal housing or a coating, for example, said protecting member being in contact with the monitored area. In terms of thermal conductivity, the protecting member of the thermal sensor of the prior art delivers poor performances, and is not capable of reacting quickly to variations of the temperature of the monitored area of the heater. Therefore known thermal sensors exhibit a slow step response to fast temperature changes, when compared with those of the thermal sensor according to the first aspect. It has been measured that the thermal transfer properties of the thermal sensor according to the first aspect may be around 10 to 20 times higher than those of conventional thermal sensors known from the art adapted to be used in a beverage preparation machine.

Moreover, according to the first aspect, the first surface and the second surface of the support are electrically isolated. As a consequence, the sensing element being thermally coupled with the first surface, the monitored area of the heater and the sensing element are electrically isolated. This configuration allows isolating electrically the sensing element from the heater.

For instance, the support has a thermal conductivity value of at least 15 W/m*K and an electrical insulation value of at least 10 kV/mm

Such characteristics allow providing a support having at least a 1500 V dielectric strength, measured between sensor and earth protection of the heater.

It has been measured that the thermal sensor having such characteristics and being properly calibrated has an absolute temperature measure accuracy of +/−1.5% at the level of 90° C. As illustrated on the FIG. 5, said thermal sensor shows a step response less than 0.3 s to temperature changes of the monitored area, providing basis to enhance drastically the effectiveness of the regulation of the heater.

A support made up for example of a ceramic material delivers these performances.

According to a second aspect, the invention relates to an assembly comprising:
a heater, adapted to heat liquid circulating through a liquid circuit in a beverage preparation machine, having a reception area;
a thermal sensor according to the first aspect, having its support held tight by fixing means onto the reception area, so as that its second surface is exposed to the heat released by the heater through the reception area.

For example, the heater of the assembly may be an in-line heater, such as a thermoblock or another heat-accumulation heater. The heater may also be an instant heating heater.

In this assembly, the second surface of the thermal sensor is fixed onto the reception area of the heater. Typically, the second surface of the support may be positioned on the outer surface of the heater and at proximity of the outlet or the inlet of the heater.

In an embodiment, the reception area may be an external and sensibly flat surface of the heater at the vicinity of a water exit of said heater. Hence, it is possible to monitor not only the variations of the liquid's temperature immediately before its exit of the heater, but also the liquid's temperature inside the heater, even when the liquid does not circulate under the action of the pump. The reception area is preferably sensibly flat to further improve the heat transfer to the sensor.

The fixing means may comprise screws, rivets, welding, hooks, guides, pressed connections, glues, mechanical fastening system, chemical fastening system, any other appropriate assembly means, or any combination of these means. This assembly provides an efficient solution to couple a heater and a thermal sensor according to the first aspect.

In an embodiment, the thermal sensor according to the first aspect is maintained on the surface of the reception area on heater surface by a clamp. As a consequence, the second surface is directly in contact with the area which temperature is to be measured: since no intermediate part is inserted, the thermal transfer is enhanced.

More particularly, the reception area, the second surface, the first surface and the sensing element are thermally coupled. The heat radiated by the reception area is directly transmitted through the support to the sensing element. Hence, fast thermal transfers through the support between the monitored area of the heater and the sensing element itself are achieved. By contrast, conventional assemblies according to the prior art do not provide a direct thermal coupling between the reception area of the heater and the sensing element, since the sensing element is covered by a protecting member, such a casting compounds, a casing, a metal housing or a coating, for example, said protecting member being in contact with the monitored area. In terms of thermal coupling between the heater and the thermal sensor, the protecting member of the thermal sensor of the prior art delivers poor performances: known thermal sensors are consequently not capable of reacting quickly to changes of the temperature of the reception area of the heater.

Moreover, according to the second aspect, the reception area and the sensing element are electrically isolated by the support positioned in-between.

In an embodiment, the fixing means may comprise a layer of thermally conductive adhesive, between the reception area and the second surface.

The thermal sensor may be covered with a cover body, with the exception of a substantial part of the second surface.

The cover body is arranged not to cover a substantial part of the second surface. Consequently, the cover body does not prevent the contact or the thermal coupling of the second surface with the reception area of the heater. The casing protects mainly from external aggressions the sensing element, the electrical coupling circuit and the ends of connector in contact with the electrical coupling circuit. The cover body may also be used as a fastening means, for example when its shape and/or its physical characteristics allow maintaining the thermal sensor fixed relatively to the reception area of the heater.

According to a third aspect, the invention relates to a heating system adapted to heat liquid circulating through a liquid circuit in a beverage preparation machine, comprising:
an assembly according to the second aspect;
control means, coupled notably with the heater and with the thermal sensor, configured to control the heater according to temperature measurements obtained from the thermal sensor.

The controller is typically coupled with the energy supply means and with the heater for supplying the required power to the latter. The controller may control the intensity of current passed to resistive heating element of the heater.

In particular, control means are configured to control notably the heater using temperature measurements obtained from the thermal sensor, so as to heat the liquid circulating through the liquid circuit according to at least one temperature command. The temperature command may include, for example, instructions, rules and/or models, taking actual temperature as input parameters. For example, a temperature command may include the sequence of actions to undertake to achieve an output temperature of 90° C., taking into consideration the current actual temperature of the reception area. For example, a simple temperature command may consist in cutting-down the power supply to the heater if the actual temperature is above 90° C., or supplying full-power to the heater if the actual temperature is below 90° C.

By using temperature measurements of the reception area of the heater, provided by a thermal sensor having low thermal inertia, the control means may implement a temperature command of the heater, and possibly of means for regulating the flow of liquid through the heater, that has an improved stability compared with the solution known from the art. Moreover, the accuracy of the actual temperature delivered by the heater is increased. Since scale deposit is greatly increased when the liquid in the heater reaches or exceeds its boiling point, the heating system may avoid or reduce the occurrences of such situation, provided its capacity to obtain more quickly the information that this boiling point is reached, thanks to the low thermal inertia of the thermal sensor according to the first aspect and the assembly according to the second aspect.

The control means may also be arranged for controlling the supply of liquid through the heater. In this embodiment, the temperature command may also take into consideration the flow circulating through the heater.

The control means may include a printed circuit board PCB, bearing one or more controllers and/or processors, quartz clocks, and memory devices.

According to a fourth aspect, the invention relates to a beverage preparation machine having a liquid circuit, comprising a heating system according to the third aspect, adapted to heat liquid circulating through said liquid circuit.

Ultimately, by having a fast reacting, precisely controlled heating system, the beverage preparation machine may deliver a beverage with an optimal perceived quality, since the accuracy of the temperature of the liquid used to prepare the beverage plays a major role of the gustative quality of many beverages, for example coffee or tea.

### BRIEF DESCRIPTION OF THE DRAWINGS

The invention will now be described with reference to the schematic drawings, wherein:

FIG. 1 shows a cross-section of a thermal sensor mounted onto a heating device for a beverage preparation machine according to an embodiment;

FIG. 2 illustrates, in a schematic perspective view, a thermal sensor mounted onto a heating device for a beverage preparation machine according to an embodiment;

FIG. 3 shows a cross-section of a thermal sensor mounted onto a heating device for a beverage preparation machine according to an embodiment;

FIG. 4 shows a schematic diagram of a thermally controlled heating system for a beverage preparation machine according to an embodiment; and,

FIG. 5 shows comparative profiles over time of the On/Off signal of a heater, of the temperature measured with a thermal sensor assembly according to an embodiment, and of the temperature measured with a state of the thermal sensor assembly; and

FIGS. 6a and 6b, shows two perspective views of an assembly of the thermal sensor onto a heating device for a beverage preparation machine according to an embodiment;

### DETAILED DESCRIPTION

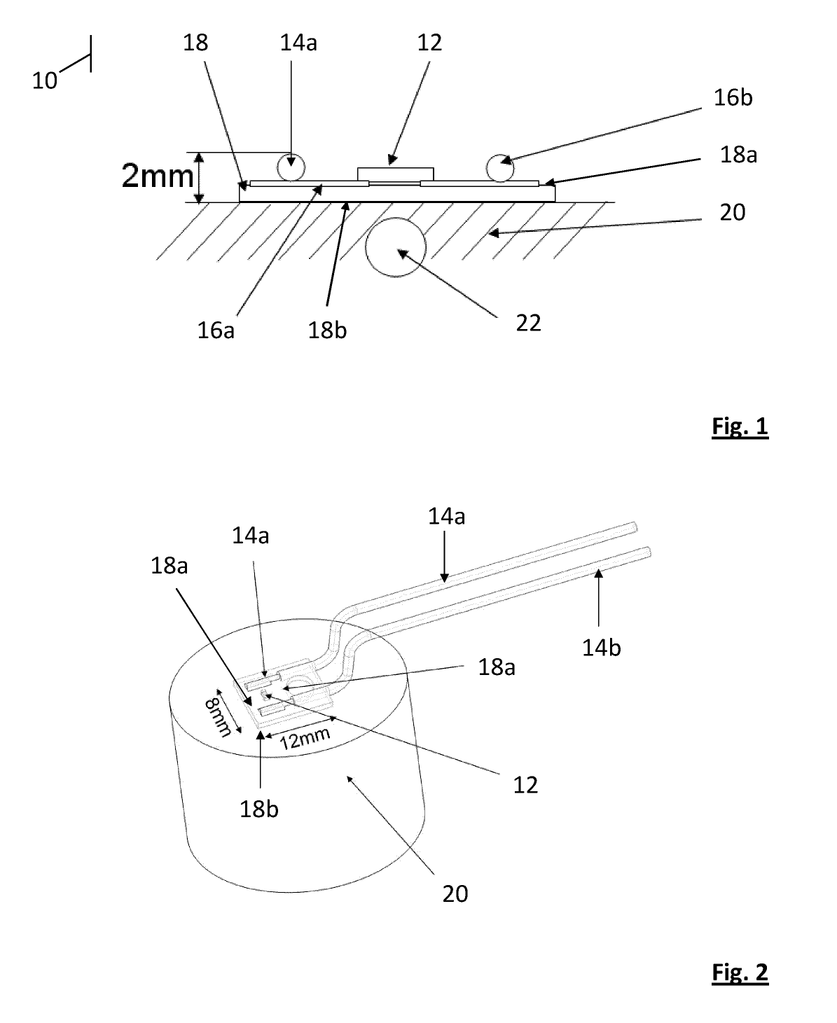

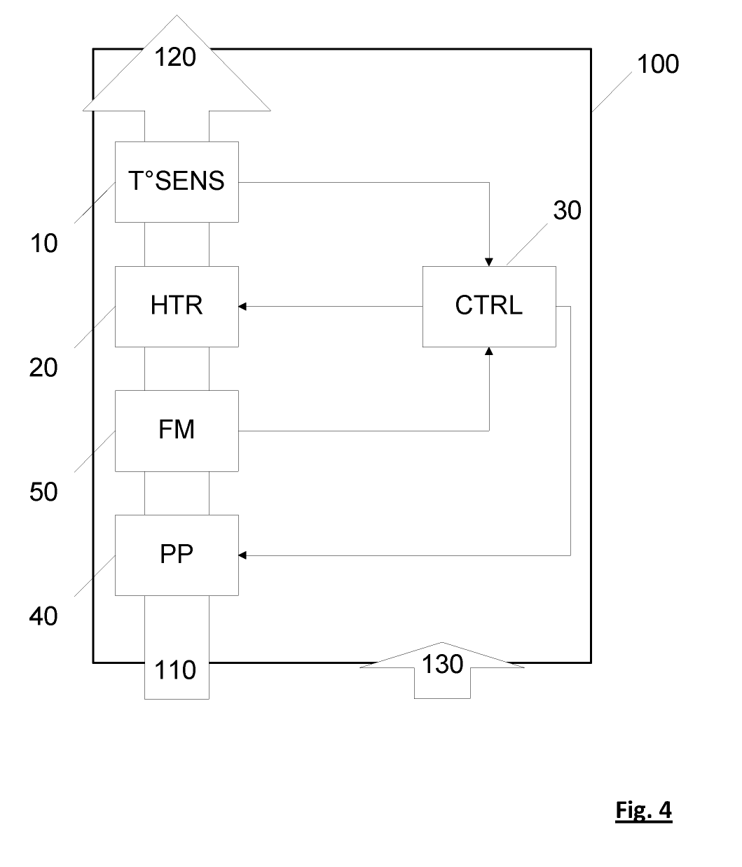

FIGS. 1 and 2 show an embodiment of a thermal sensor 10 intended to be used typically for a beverage preparation machine, such as a coffee machine. The thermal sensor 10 comprises a sensing element 12 having at least one measurable electrical quantity varying with the temperature of said sensitive element. The sensing element is electrically coupled with connectors 14a, 14b through an electrical coupling circuit 16a, 16b. The connectors, the electrical coupling circuit and the sensing element are arranged to form part of an electrical circuit. The connectors and the electrical coupling circuit are disposed and assembled to allow measuring the measurable electrical quantity varying with the temperature of the sensitive element 12.

In an embodiment, the sensing element is rigidly mounted into the upper surface of the support.

For example, in the embodiment illustrated by FIG. 1, the electrical coupling circuit 16 comprises a first electrical track 16a connected at one end to the first connector 14a, and at the other end to a first extremity of the sensing element 12. The electrical coupling circuit 16 comprises then a second electrical track 16b connected at one end to the second connector 14b, and at the other end to a second opposite extremity of the sensing element 12. The first and second electrical tracks are moreover disjoined.

The sensing element may be brazed to the electrical coupling circuit. The first and second electrical tracks may be sheathed cables, soldered to the electrical tracks.

In the embodiment shown on FIG. 2, the electrical coupling circuit 16 is directly applied onto the upper surface of the support, for instance using thick film printing methods, or PVD physical vapor deposition. In particular the electrical coupling circuit 16 may be constituted of metalized tracks.

The thermal sensor may be a thermistor. In this latter embodiment, the resistance of the sensing element varies with its temperature. Any variations of the resistance can be measured between the two connectors and can be translated into variations of the temperature of the sensing element. Moreover, by calibrating the sensing element or stated otherwise by determining for the sensing element a response profile of resistance values depending of the temperature (generally an almost linear profile for the intended range of measurable temperatures), it is possible to determine a value of temperature knowing the resistance value. In particular, the thermal sensor may be of a positive temperature coefficient (PTC) type having its sensing element which resistance increases with the rise of its temperature. The sensing element of such a PTC thermistor can be made of a sintered semiconductor material.

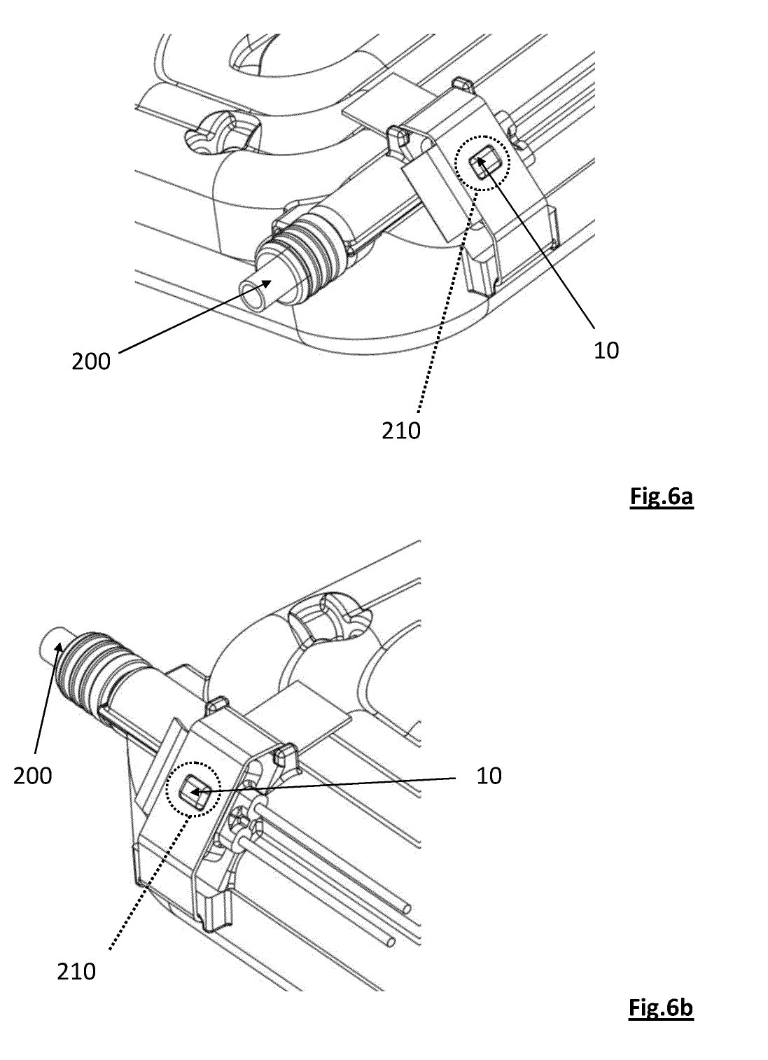

The thermal sensor comprises an electrical insulating support 18 having an upper surface 18a and a lower surface 18b. It is understood that the “lower” and “upper” references merely refer to the particular orientation of thermal sensor as illustrated in FIG. 1, 2 or 3. The sensing element is disposed on the upper surface 18a or at least in the immediate vicinity of the upper surface 18a. The lower surface 18b of the support is intended to be positioned onto, or at least thermally coupled with, a reception area of a heater 20. The reception area corresponds to the surface of the heater where the variations of the temperature have to be monitored by the thermal sensor. A typical location for the reception area is located near an inlet or an outlet of the heater. In an embodiment, as illustrated on FIGS. 6a and 6b, the reception area 210 is an external and sensibly flat surface of the heater at the vicinity of a water exit 200 of said heater. Hence, it is possible to monitor not only the variations of the liquid's temperature immediately before its exit of the heater, but also the liquid's temperature inside the heater, even when the liquid does not circulate under the action of the pump. The reception area is preferably sensibly flat to further improve the heat transfer to the sensor.

The support ensures that no electrical current circulates between the reception area and the sensing element. On another hand, the support couples thermally the sensing element to the reception area. To this end the support may be made mainly of at least one electrical insulating material having a typical thermal conductivity of at least 15 W/m*K.

FIG. 5 shows by a diagram the step response of a thermal sensor according to the invention assembled with a heater, and the step response of a known PTC thermal sensor used in conventional beverage preparation machine. The X-axis of the diagrams represents time in seconds whereas the Y-axis shows temperature in Celsius degrees. The heater is powered-on during the period comprised between 10 and 20 seconds and power-off otherwise. A first curve represents the temperature measured by the PTC thermal sensor according to the state of the art. A second curve represents the temperature measured by the thermal sensor according to an embodiment of the invention. It appears clearly that the thermal sensor according to an embodiment of the invention shows a typical step response of 0.3 s when, in similar conditions, the thermal sensor according to the prior art has a typical step response of 3 s.

In an embodiment, the support is sensibly a plane having an average thickness, measured between its upper and lower surfaces, comprised between 0.2 mm and 2 mm. The support may be made up mainly of a ceramic material such as Al2O3. In this configuration, the support can present a dielectric strength, i.e. a maximum electric field strength that the support can withstand intrinsically without experiencing failure of its electrical insulating properties, of at least 1250 V, as required by IEC 60335-1.

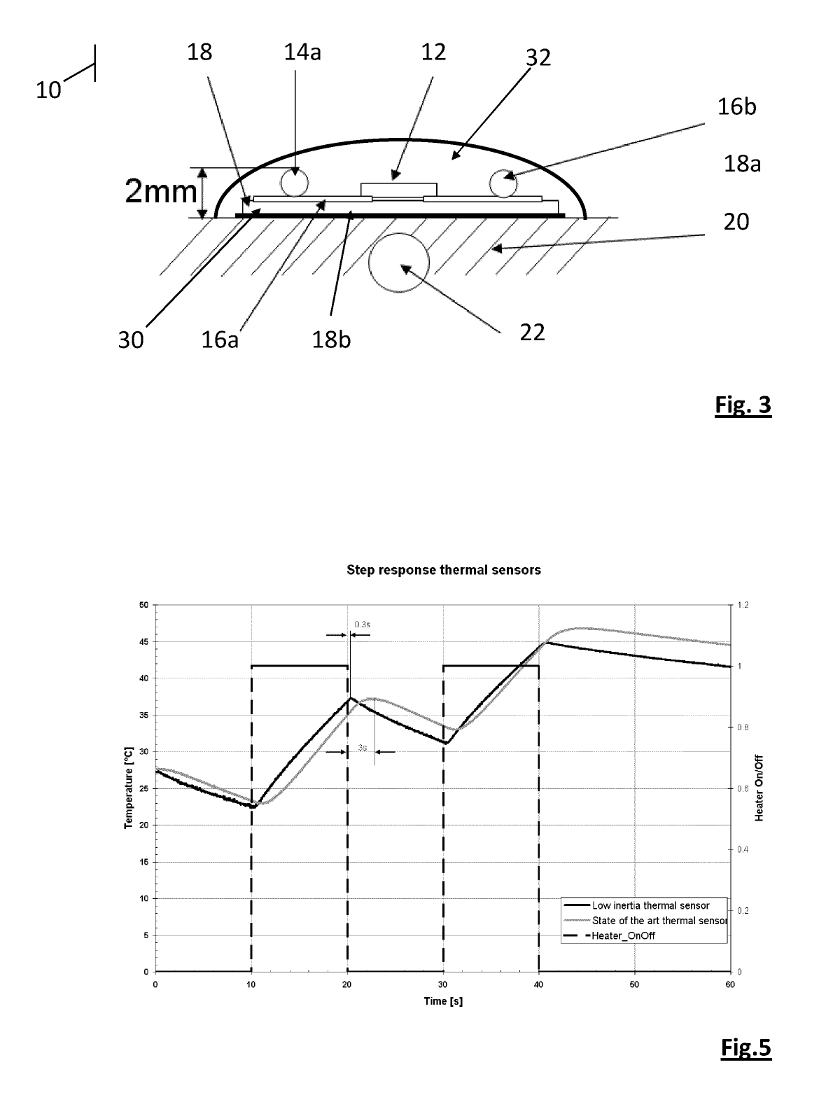

The support of the thermal sensor may be held tight by fixing means onto the reception area of the heater, so as that the sensing element is as close as possible of the reception area. As illustrated on FIGS. 1 and 3, the lower surface 18b of the support may be positioned on the outer surface of the heater and directly on top of the outlet of the heater. The fixing means may comprise screws, rivets, welding, hooks, guides, pressed connections, glues, mechanical fastening system, chemical fastening system, any other appropriate assembly means, or any combination of these means. The lower surface of the support is then rigidly secured onto the reception area.

Hence, upon assembly of thermal sensor onto the reception area of the heater, the lower surface of the support of the thermal sensor is exposed to the heat released by the heater through its reception area. The heat radiated by the heater through its reception area is, by the way of consequence, transmitted to the sensing element.

In an embodiment, as shown on FIG. 3, the fastening means comprise a layer 30 of thermally conductive adhesive, between the reception area of the heater and the lower surface 18b of the support. The material used to form the layer 30 may also be an electrically isolating adhesive material.

In an embodiment, as shown on FIG. 3, the thermal sensor may be covered partially by a cover body 30. The cover body does not extend significantly towards the lower surface 18b, leaving it substantially uncovered. Consequently, the cover body does not prevent the contact or the thermal coupling between the lower surface and the reception area of the heater. The cover body protects mainly, from external aggressions, the sensing element, the electrical coupling circuit and the ends of connector in contact with the electrical coupling circuit. The cover body may be manufactured by injection moulding. The cover body may also be obtained by applying a heated thermofusible material, i.e. a synthetic resin, on top of the thermal sensor, once the latter is attached to the heater. The cover body may also be used as a fastening mean, for example if its shape and/or its physical characteristics allow maintaining the thermal sensor fixed relatively to the reception area of the heater. For example the cover body may be fastened to the heater using screws going across said cover body up to the heater body, the inner shape of the cover body being adapted to apply a force onto the thermal sensor so as that the lower surface of its support remains in contact with the reception area of the heater.

FIG. 4 shows a schematic diagram of a thermally controlled heating system 100 for a beverage preparation machine according to an embodiment. The heating system comprises a liquid inlet 110 adapted to be coupled with a liquid tank of the beverage preparation machine. The heating system comprises also a liquid outlet 120 to provide heated liquid to the beverage preparation machine. The heating system comprises energy supply means 130, for example an energy supply inlet to receive from the beverage preparation machine energy (for example, electricity and/or gas and/or pneumatic flow). The heating system may, alternatively or in complement, embedded its own energy sources, for example by embedding batteries, electrical generators, and/or gas storage. Liquid is circulated through the heater system from the liquid inlet to a liquid outlet. The liquid outlet of the heating system is arranged to be in connection with a brewing chamber of the beverage machine. The brewing chamber is capable of brewing a beverage ingredient supplied into the brewing chamber. An example of such a beverage machine is disclosed in detail WO 2009/130099. For instance, a beverage ingredient is supplied to the machine in a capsule. Typically, this type of beverage machine is suitable to prepare coffee, tea and/or other hot beverages or even soups and like food preparations. The pressure of the liquid circulated to the brewing chamber may for instance reach about 1 to 25 bar, in particular 5 to 20 bar such as 10 to 15 bar or in particular 1 to 3 bar.

The heating system includes the thermal sensor 10 and the heater 20 coupled with the liquid inlet and outlet of the heating system. The reception area of the heater, where the lower surface of the support of the thermal sensor is fixed, is for instance located near the outlet of the heater. The heater heats the flow of liquid passing through the heating device. The heater may be an in-line heater, such as a thermoblock or another heat-accumulation heater. Alternatively the heater may be an instant heating heater. Further details of the heater and its integration in a beverage preparation machine are for example disclosed in WO 2009/043630, WO 2009/043851, WO 2009/043865 and WO 2009/130099.

The heating system comprises a pump 40 for pumping liquid through the heater 20. The heating system also includes a flowmeter to measure the flow of liquid circulating through the heating system. More particularly, the flowmeter may comprise a hall-effect sensor and is located on the liquid circuit, typically between the pump and the liquid inlet, or between the pump and the heater, or within the heater.

The heating system further comprises a controller 30 for controlling notably the in-line heater and the pump based upon the measures performed by the flowmeter and the thermal sensor and according to temperature and flow instructions, rules and/or models. The controller 30 is arranged for controlling the supply of liquid, via the pump and heater, so that heater is energised to reach and be maintained at an operative temperature for heating up the supply of liquid to the beverage preparation temperature during beverage preparation.

The controller may be composed by a printed circuit board PCB, bearing one or more controllers and/or processors, quartz clocks, and memory devices.

In an embodiment the controller is shared between the heating system and the beverage machine. In this latter embodiment, the controller may implement additional functionalities, for instance receiving and processing instructions from a user via an interface.

The controller is coupled with the flowmeter 50 and the thermal sensor 10 for receiving measurements of the liquid flow and the temperature variations. More particularly, the controller is electrically connected to a sensor of a flowmeter that is located on the liquid circuit, typically between the pump and the liquid inlet, or between the pump and the heater, or within the heater.

The controller is coupled with the energy supply means to be supplied with electrical power and with the pump and the heater for supplying the required power to operate them and control their respective operation and action.

For example the controller may control the intensity of current passed to resistive heating element and to the motor operating the pump, based on the flow rate of the circulating water measured with the flow meter and the temperature of the heated water measured with the thermal sensor.

1. Thermal sensor comprising:
connectors;
an electrical coupling circuit;
a sensing element having at least one measurable electrical quantity varying with the temperature of the sensing element;
the sensing element being electrically coupled with the connectors through the electrical coupling circuit so as to allow measuring the electrical quantity at the level of the connectors; and a support having a first surface and a second surface, the first and the second surfaces being thermally coupled and electrically isolated, the sensing element being thermally coupled with the first surface, and the second surface being adapted to be thermally coupled with an area where temperature is to be measured.

2. Thermal sensor according to claim 1, wherein the support has a thermal conductivity value of at least 15 W/m*K.

3. Thermal sensor according to claim 1, wherein the support has an electrical insulation value of at least 2 kV.

4. Thermal sensor according to claim 1, wherein the support is made of a ceramic material.

5. Assembly comprising:
a heater, adapted to heat liquid circulating through a liquid circuit in a beverage preparation machine, having a reception area;
a thermal sensor comprising: connectors; an electrical coupling circuit; a sensing element having at least one measurable electrical quantity varying with the temperature of the sensing element; the sensing element being electrically coupled with the connectors through the electrical coupling circuit so as to allow measuring the electrical quantity at the level of the connectors; and a support having a first surface and a second surface, the first and the second surfaces being thermally coupled and electrically isolated, the sensing element being thermally coupled with the first surface, and the second surface being adapted to be thermally coupled with an area where temperature is to be measured having its support held tight by a fixing member onto the reception area, so that its second surface is exposed to the heat released by the heater through the reception area.

6. Assembly according to claim 5, wherein the reception area is an external and substantially flat surface of the heater located at the vicinity of a water exit of the heater.

7. Assembly according to claim 5, wherein the fixing member comprises a layer of thermally conductive adhesive, between the reception area and the second surface.

8. Assembly according to claim 5, wherein the fixing member comprises a clamp for maintaining the thermal sensor onto the reception area

9. Assembly according to claim 5, wherein the thermal sensor is covered with a cover body, with the exception of a substantial part of the second surface.

10. Heating system adapted to heat liquid circulating through a liquid circuit in a beverage preparation machine, comprising:
an assembly comprising:
a heater, adapted to heat liquid circulating through a liquid circuit in a beverage preparation machine, having a reception area;
a thermal sensor comprising: connectors; an electrical coupling circuit; a sensing element having at least one measurable electrical quantity varying with the temperature of the sensing element; the sensing element being electrically coupled with the connectors through the electrical coupling circuit so as to allow measuring the electrical quantity at the level of the connectors; and a support having a first surface and a second surface, the first and the second surfaces being thermally coupled and electrically isolated, the sensing element being thermally coupled with the first surface, and the second surface being adapted to be thermally coupled with an area where temperature is to be measured having its support held tight by a fixing member onto the reception area, so that its second surface is exposed to the heat released by the heater through the reception area; and
a controller coupled with the heater and with the thermal sensor, and configured to control the heater according to temperature measurements obtained from the thermal sensor.

11. A beverage preparation machine having a liquid circuit, comprising a heating system adapted to heat liquid circulating through a liquid circuit in a beverage preparation machine, comprising:
an assembly comprising:
a heater, adapted to heat liquid circulating through a liquid circuit in a beverage preparation machine, having a reception area;
a thermal sensor comprising: connectors; an electrical coupling circuit; a sensing element having at least one measurable electrical quantity varying with the temperature of the sensing element; the sensing element being electrically coupled with the connectors through the electrical coupling circuit so as to allow measuring the electrical quantity at the level of the connectors; and a support having a first surface and a second surface, the first and the second surfaces being thermally coupled and electrically isolated, the sensing element being thermally coupled with the first surface, and the second surface being adapted to be thermally coupled with an area where temperature is to be measured having its support held tight by a fixing member onto the reception area, so that its second surface is exposed to the heat released by the heater through the reception area; and
a controller coupled with the heater and with the thermal sensor, and configured to control the heater according to temperature measurements obtained from the thermal sensor adapted to heat liquid circulating through the liquid circuit.
